(19) United States
(12) Patent Application Publication
(10) Pub. No.: US 2001/0006381 A1
(43) Pub. Date: Jul. 5, 2001

(54) Finger-scale mouse casing structure

(76) Inventor: Meng-Yu Wei, Taipei (TW)

Correspondence Address: EZRA SUTTON, P. A., Plazza 9, 900 Route 9, Woodbridge, NJ, 07095, US

(21) Appl. No.: 09/745,267

(22) Filed: Dec. 21, 2000

(30) Foreign Application Priority Data
Dec. 23, 1999 (TW) 88221933

(51) Int. Cl. G09G 5/08

(52) U.S. Cl. 345/163

(57) ABSTRACT

A finger-scale mouse casing structure is proposed, which allows the user to hold and move the mouse in a more effortless manner than the prior art, and also allows the overall mouse size to be made more compact than the prior art. This finger-scale mouse casing structure comprises: a base part for accommodating a movement-detection circuit; a first sidewall which is substantially upright erected on a first lateral side of the base part; a second sidewall which is substantially upright erected on a second lateral side of the base part; and a set of buttons disposed on the base part. With this finger-scale mouse casing structure, the user can hold and move the mouse simply by moving his/her thumb and fingers, without having to turn his/er wrist and elbow, thus preventing the Carpal tunnel syndrome. Moreover, the overall mouse size can be made to the finger scale, which is significantly more compact than the conventional palm-scale mouse casing structure:

### BACKGROUND OF THE INVENTION

1. Field of the Invention:

This invention relates to computer technology, and more particularly, to a finger-scale mouse casing structure which allows the user to hold and move the mouse in a more effortless manner than the prior art, and also allows the overall mouse size to be made more compact than the prior art.

2. Description of Related Art:

A mouse is an essential peripheral device of a computer system running on a graphic-based operating system, which allows the user to operate the computer more conveniently. Conventional mouse devices are typically encased in a palm-scale mouse casing structure which is sized to suit a human's palm. The palm-scale mouse casing structure, however, is considered too large to take up much of the desktop area and would cause stress and injury to the user's hand after lengthy time of use.

FIG. 1 is a schematic perspective view of a conventional palm-scale mouse casing structure 100. As shown, the mouse casing structure 100 includes a top source 110, a side surface 120, and a pair of buttons 130, 140. The inside circuit structure of the mouse can be conventional or new, but which is not within the spirit and scope of the invention, so description thereof will not be detailed. The top surface 110 is curved in such a manner that it would be comfortably fitted to a human's palm. When operating the mouse, the user can rest his/her palm on the top surface 110, hold the side surface 120 by his/her thumb and litter finger, and use his/her index finger to press on the left button 130 and his/her middle finger to press on the right button 140. To move the cursor on the computer screen, the user needs to move the entire mouse casing 100 around the desktop.

One drawback to the forgoing palm-scale mouse-casing structure, however, is that it requires the user to turn his/her wrist and elbow when moving the mouse around the desk-top, and therefore, in the event that the movement is lengthy in distance, it may cause stress and injury to the user's hand. As a consequence, after lengthy time of use, it can easily cause the so-called Carpal tunnel syndrome to the users hand.

Still one drawback is that, although today's technology can make the inside mouse circuit quite small in size, the overall mouse casing structure of FIG. 1 is nevertheless large due to its palm-scale design. This would make the mouse relatively non-compact in size.

### SUMMARY OF THE INVENTION

It is therefore an objective of this invention to provide a finger-scale mouse casing structure, which allows the user to operate the mouse by using just his/her thumb and fingers, without having to turn his/her wrist and elbow, so that the Carpal tunnel syndrome can be prevented.

It is another objective of this invention to provide a finger-scale mouse casing structure, which allows the overall mouse size to be made more compact as compared to the conventional palm-scale mouse casing structure.

In accordance with the foregoing and other objectives, the invention proposes a finger-scale mouse casing structure. The finger-scale mouse casing structure of the invention comprises: a base part for accommodating a movement-detection circuit; a left sidewall which is substantially upright erected on the left lateral side of the base part; a right sidewall which is substantially upright erected on the right lateral side of the base part; and a set of buttons disposed on the base part. Further, the mouse casing structure comprises a back sidewall which is substantially upright erected on the back side of the base part; and the left, right, and back sidewalls are substantially U-shaped when viewing from the top.

With the finger-scale mouse casing structure of the invention, the user can hold and move the mouse in various ways. For instance, the user can use his/her thumb and index finger to seize the left sidewall when moving the mouse over the desktop. Alternatively, the user can use his/her index finger and middle finger to seize the right sidewall when moving the mouse over the desktop. Still moreover, the user can use his/her thumb and middle finger to seize the left sidewall and the right sidewall when moving the mouse over the desktop.

The finger-scale mouse casing structure of the invention allows the user to hold and move the mouse in a more effortless manner than the prior art, and also allows the overall mouse size to be made more compact than the prior art. With the invention, the user needs just to move the mouse by using his/her thumb and fingers, without having to turn his/her wrist and elbow, thus preventing the Carpal tunnel syndrome.

### BRIEF DESCRIPTION OF DRAWINGS

The invention can be more fully understood by reading the following detailed description of the preferred embodiments, with reference made to the accompanying drawings, wherein:

FIG. 1 (PRIOR ART) is a schematic perspective view of a conventional palm-size mouse casing structure;

FIG. 2 is a schematic perspective view of a first preferred embodiment of the mouse casing structure of the invention;

FIG. 3 is a schematic side view of the mouse casing structure of FIG. 2;

FIG. 4 is a schematic perspective view used to depict a first manner in which a user can hold and move the mouse casing structure of the invention;

FIG. 5 is a schematic perspective view used to depict a second manner in which a user can hold and move the mouse casing structure of the invention;

FIG. 6 is a schematic perspective view used to depict a third manner in which a user can hold and move the mouse casing structure of the invention;

FIG. 7 is a schematic perspective view used to depict a fourth manner in which a user can hold and move the mouse casing structure of the invention;

FIG. 8 is a schematic perspective view of a second preferred embodiment of the mouse casing structure of the invention; and

FIG. 9 is a schematic perspective view of a third preferred embodiment of the mouse casing structure of the invention.

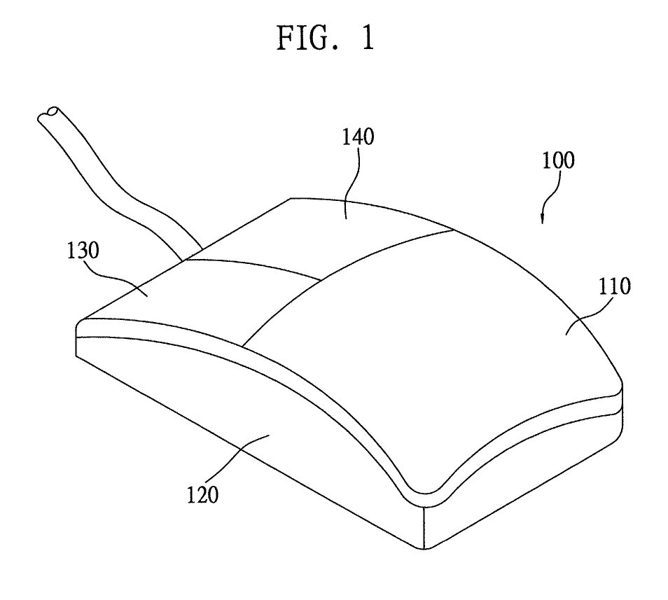

### DETAILED DESCRIPTION OF PREFERRED EMBODIMENTS

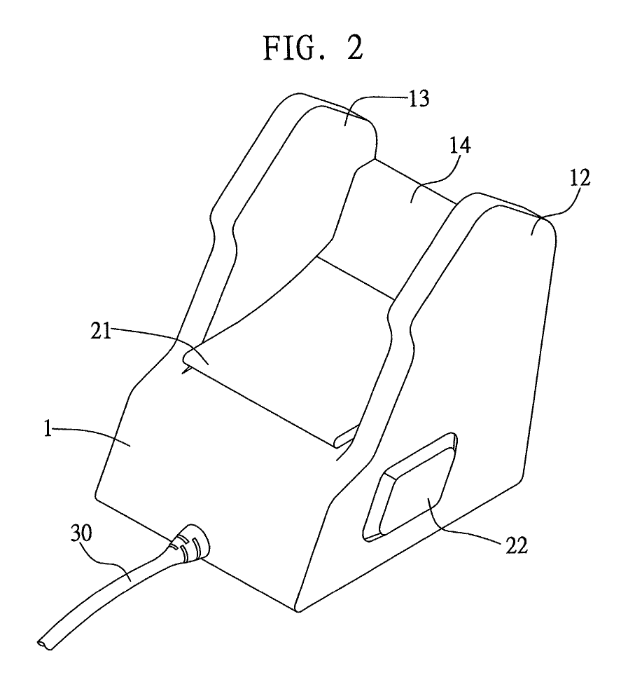

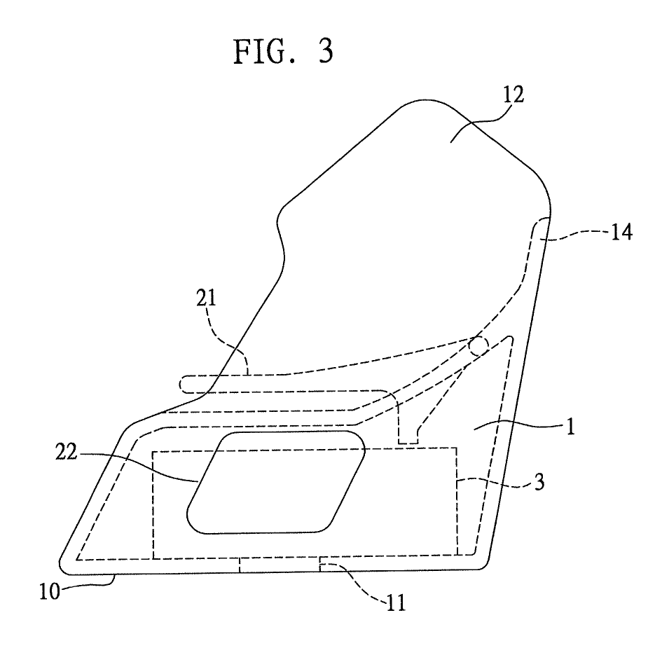

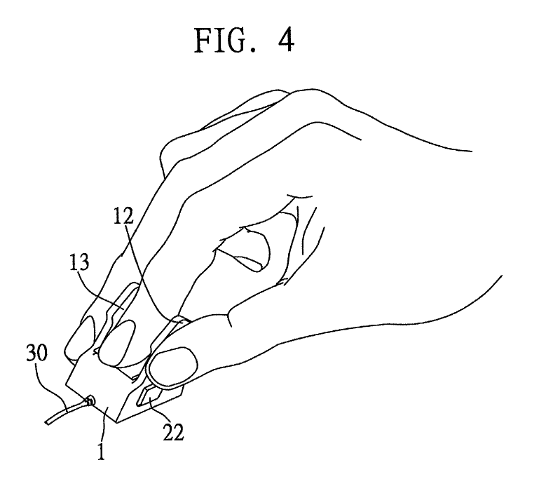

FIG. 2 is a schematic perspective view of a first preferred embodiment of the finger-scale mouse casing structure of the invention, FIG. 3 shows a schematic sectional view of the same; and FIGS. 4-7 show how the user can hold and move the finger-scale mouse casing structure of the invention.

As shown the finger-scale mouse casing structure of the invention includes a base part 1, a left sidewall 12, a right sidewall 13, and a back sidewall 14. Further, the mouse casing structure includes a first button 21 and a second button 22 (a third button 23 can be further arranged, as shown in FIG, 6). The first button 21 is disposed on the top of the base part 1 and within the space defined by the left sidewall 12, the right sidewall 13, and the back sidewall 14. The second and third buttons 22, 23 are disposed respectively on the opposite lateral sides of the base part 1. A cable 30 is used to connect the mouse to a computer (not shown). Further, as shown in FIG. 3, the base part 1 having a flat bottom side 10 formed with a hole 11 through which the movement of the mouse can be detected by a movement detection circuit 3 mounted within the hollowed inside space of the base part 1.

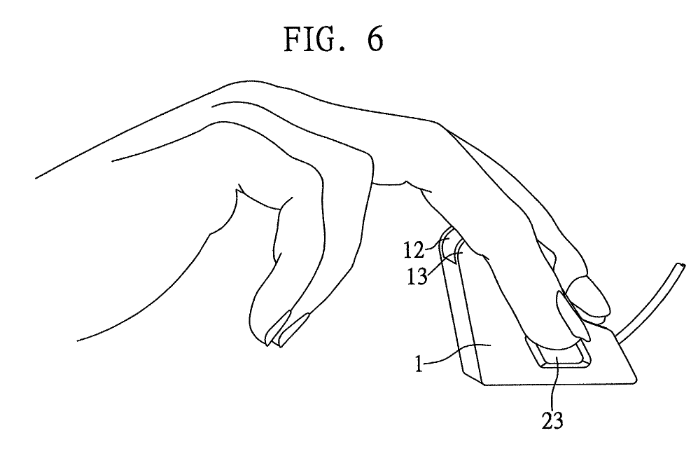

Referring to FIG. 4, during operation, the user can attach his/her thumb to the left sidewall 12 above the second button 22 and his/her middle finger to the right sidewall 13 above the third button 23 (FIG. 6), while inserting his/her index fingertip into the space between the left sidewall 12 and the right sidewall 13. When the user wants to move the mouse around the desktop, he/she needs just to slightly move his/her thumb and fingers. The provision of the back sidewall 14 can help allow the user to use just his/her index finger to move the mouse in the backward direction. When it is required to move the mouse over a greater distance, the user needs to move his/her thumb and middle finger. All of these movement actions can be achieved without requiring the user to turn his/her wrist and elbow as in the case of the prior art. Therefore, the invention can help prevent the user from getting the Carpal tunnel syndrome.

As shown in FIG. 2 and 3 the top surface of the base part 1, where the first button 21 is disposed, is structured in such a manner that it is slightly larger in width than a human's index finger and is upward-slanted towards the back sidewall 14 so that the user's index fingertip can comfortably rest-thereon. During the mouse operation, the user can use his/her index finger to press on the first button 21, his/her thumb to press on the second button 22, and his/her middle finger to press on the third button 23. Although this embodiment is designed a three-button mouse, the invention is also suitable for a two-button mouse, in which case the second button 22 or the third button 23 can be eliminated.

As shown in FIG. 2, during movement of the mouse, the movement-detection circuit 3 can detect the displacement and direction of the mouse through the hole 11, and the detected information is then transferred via the cable 30 to the associated computer (not shown). The movement-detection circuit 3 can be a conventional circuit such as a ball type or an optical type. The inside circuit structure of the movement-detection circuit 3 is conventional and not within the spirit and scope of the invention, so description thereof will not be further detailed.

With the finger-scale mouse casing structure of the invention; the user can hold and move the mouse in various ways.

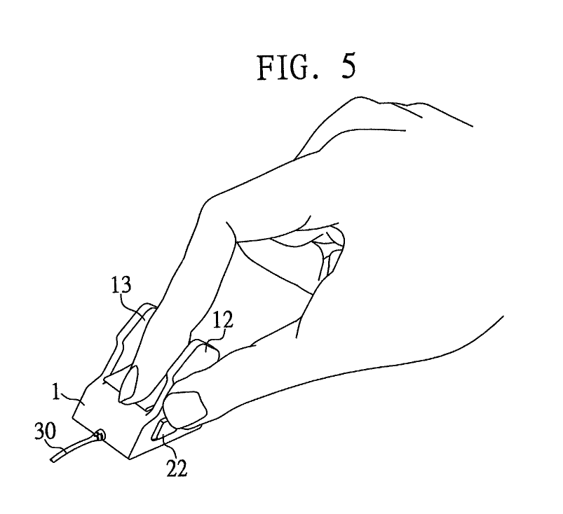

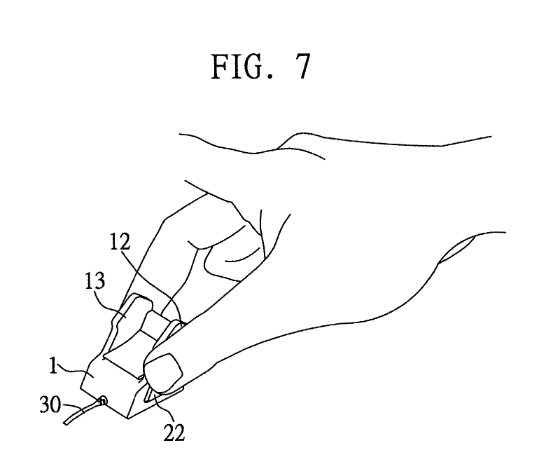

For instance, as shown in FIG. 5, the user can use his/her thumb and index finger to seize the left sidewall 12 when moving the mouse over the desktop. Alternatively, as shown in FIG, 6, the user can use his/her index finger and middle finger to seize the right sidewall 13 when moving the mouse over the desktop. Still moreover, as shown in FIG. 7, the user can use his/her thumb and middle finger to seize the left sidewall 12 and the right sidewall 13 when moving the mouse over the desktop.

Therefore, it can be seen that the finger-scale mouse casing structure of the invention allows the user to move the mouse simply by using his/her thumb, index finger, and middle finger together, or any two of them, without having to turn his/her wrist and elbow. The invention thus allows the user to move the mouse in a more effortless manner than the prior art and can help prevent the user from getting the Carpal tunnel syndrome.

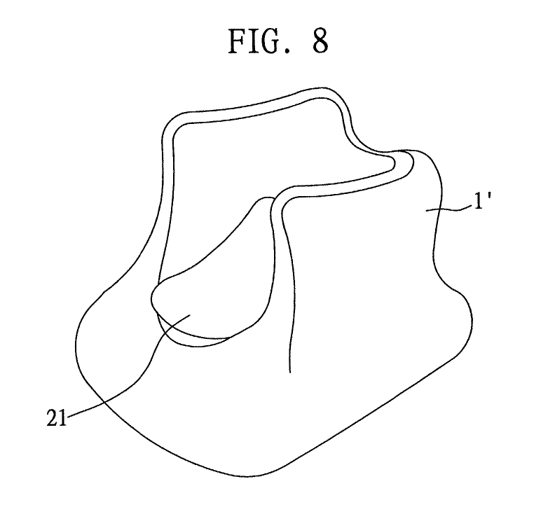

FIG. 8 is a schematic perspective view of a second preferred embodiment of the mouse casing structure of the invention. This embodiment is substantially the same as the previous one except its outer appearance is more ergonomically modified to allow the user to hold the mouse more comfortably.

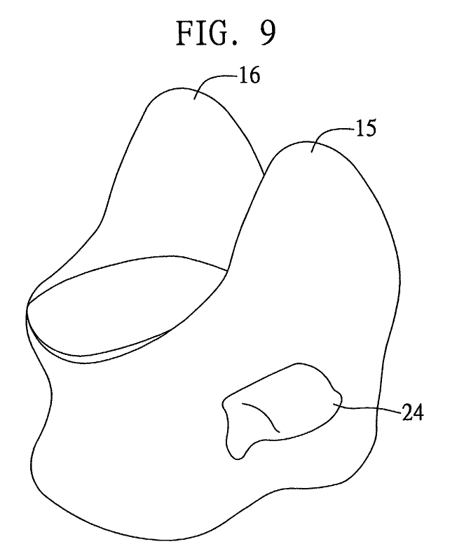

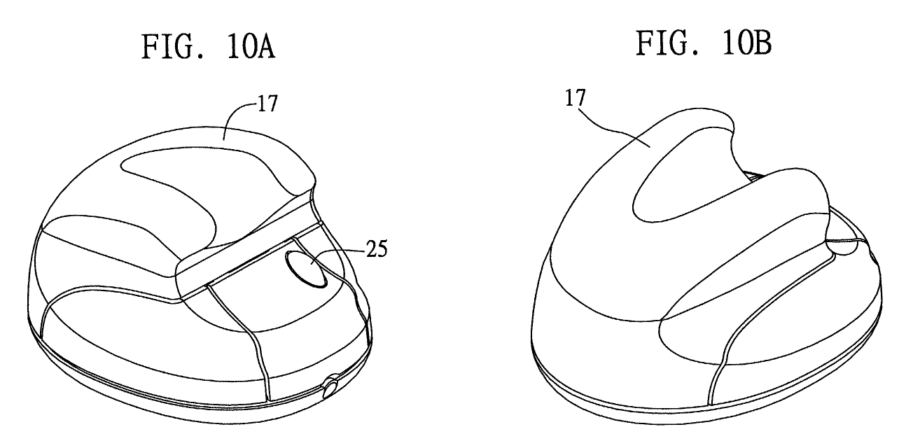

FIG. 9 is a schematic perspective view of a third preferred embodiment of the mouse casing structure of the invention. This embodiment is substantially the same as the previous two except its left and right sidewalls are each formed with a rounded top side.

In conclusion, the invention provides a finger-scale mouse casing structure which allows the user to hold and move the mouse in a more effortless manner than the prior art, and also allows the overall mouse size to be made more compact than the prior art. With the invention, the user needs just to move the mouse by using his/her thumb and fingers, without having to turn his/her wrist and elbow, thus preventing the Carpal tunnel syndrome.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A mouse casing structure which comprises:
a) a base part for accommodating a movement-detection circuit;
b) a first sidewall which is substantially upright erected on a first lateral side of the base part;
c) a second sidewall which is substantially upright erected on a second lateral side of the base part; and
d) a set of buttons disposed on the base part.

2. The mouse casing structure of claim 1, further comprising:
a) a third sidewall which is substantially upright erected on the back side of the base part; where the first, second, and third sidewalls are substantially U-shaped when viewing from the top.

3. The mouse casing structure of claim 1, wherein the button set includes a first button disposed on the top of the base part.

4. The mouse casing structure of claim 3, wherein the button set includes a second button disposed on a first lateral side of the base part.

5. The mouse casing structure of claim 4, wherein the button set includes a third button disposed on a second lateral side of the base part.

6. The mouse casing structure of claim 1, wherein the movement detection circuit is encased in the hollowed inside space of the base part.

7. The mouse casing structure of claim 1, wherein the movement-detection circuit is a ball type.

8. The mouse casing structure of claim 1, wherein the movement-detection circuit is an optical type.

9. The mouse casing structure of claim 1, wherein the first and second sidewalls are each formed in a curved shape.

10. The mouse structure of claim 1, wherein the top surface of the base part is formed in a slanted shape.

11. The mouse casing structure of claim 1, wherein the first and second sidewalls are separated from each other by a distance at least large enough to allow a human's fingertip to insert into the space defined therebetween.

12. The mouse casing structure of claim 1, wherein the first and second sidewalls are each formed into a rounded shape.

13. The mouse casing structure of claim 2, wherein the button set includes a first button disposed on the top of the base part.

14. The mouse casing structure of claim 13, wherein the button set includes a second button disposed on a first lateral side of the base part.

15. The mouse casing structure of claim 14, wherein the button set includes a third button disposed on a second lateral side of the base part.

16. The mouse casing structure of claim 2, wherein the movement-detection circuit is encased in the hollowed inside space of the base part.

17. The mouse casing structure of claim 2, wherein the first and second sidewalls are each formed in curved shape.

18. The mouse casing structure of claim 2, wherein the top surface of the base part is formed in a slanted shape.
